(19) United States
(12) Patent Application Publication
(10) Pub. No.: US 2009/0144793 A1
(43) Pub. Date: Jun. 4, 2009

(54) METHOD FOR OBTAINING SERVICE MAP INFORMATION, APPARATUS THEREFOR, AND METHOD FOR FAST PERFORMING APPLICATION IN SERVICE ACCORDING TO THE SERVICE MAP INFORMATION

(75) Inventor: Chi-Chia LIN, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/949,252

(22) Filed: Dec. 3, 2007

(51) Int. Cl. H04N 7/173

(52) U.S. Cl. 725/116

(57) ABSTRACT

A method for decoding a packetized transport stream containing a service comprising a program and an application is provided. The method includes steps as follows. Firstly, identify a program map information corresponding to the program and an application information corresponding to the application conveyed in the transport stream. Then, assemble at least part of the identified program map information and at least part of the identified application information to obtain a service map information. The service map information associates the program with packet identifiers used to identify individual packets of the transport stream that constitute the program, and associates the application with packet identifiers used to identify individual packets of the transport stream for performing the application. Then, store the service map information. The service map information can be used to identify the individual packets of the transport stream of the service when the service is chosen again.

### BACKGROUND OF THE INVENTION

1. Field of the Invention

The invention relates in general to a method for performing an application in a service, and more particularly to a method for obtaining a service map information, an apparatus therefore, and a method for fast performing an application in a service according to the service map information.

2. Description of the Related Art

In a digital video broadcast (DVB) standard of the digital TV technology, a channel can transmit several programs from a broadcaster to a receiver. A service, including a program and at least one application, is a basic unit that a user can use. To completely perform a service, service information is required. The service information contains all information needed for performing the service, such as a program map table (PMT) and application information needed for performing the application. The PMT is referred to get some of the packet identifiers used to identify individual packets of a transport stream that constitutes the program. The application information is used to get the packet identifier used to identify individual packets of the transport stream for performing the application.

However, every time before performing the service, it is required to get the service information from the transport stream, which is very time-consuming. The waiting time before the service is starting to being performed each time will be very long. Thus, it is highly desired to provide a method for fast performing the service.

### SUMMARY OF THE INVENTION

The invention is directed to a method for decoding a packetized transport stream containing a service comprising a program and an application. The method obtains and stores a service map information. With the stored service map information, when the service is chosen again, the service can be performed very quickly according to the stored service map information.

According to a first aspect of the present invention, a method for decoding a packetized transport stream containing a service comprising a program and an application is provided. The method includes steps as follows. Firstly, identify a program map information corresponding to the program and an application information corresponding to the application conveyed in the transport stream. Then, assemble at least part of the identified program map information and at least part of the identified application information to obtain a service map information. The service map information associates the program with packet identifiers used to identify individual packets of the transport stream that constitute the program, and associates the application with packet identifiers used to identify individual packets of the transport stream for performing the application. Then, store the service map information. The service map information can be used to identify the individual packets of the transport stream of the service when the service is chosen again.

According to a second aspect of the present invention, an apparatus for decoding a packetized transport stream to perform an application is provided. The apparatus includes a storage device, a data processor, and an application manager. The storage device stores a service map information associating the application with packet identifiers used to identify individual packets of the transport stream. The data processor reads the service map information from the storage device and generates at least one application file constituted by individual packets of the transport stream for performing the application according to the service map information. The application manager executes the at least one application file according to the service map information, so as to perform the application.

According to a third aspect of the present invention, an apparatus for decoding a packetized transport stream containing a service comprising a program and an application is provided. The apparatus includes a storage device and a processor. The processor identifies a program map information corresponding to the program and an application information corresponding to the application conveyed in the transport stream, assembles at least part of the identified program map information and at least part of the identified application information to obtain a service map information, and stores the service map information into the storage device. The service map information associates the program with packet identifiers used to identify individual packets of the transport stream that constitute the program, and associates the application with packet identifiers used to identify individual packets of the transport stream for performing the application. The service map information can be used to identify the individual packets of the transport stream of the service when the service is chosen again.

The invention will become apparent from the following detailed description of the preferred but non-limiting embodiments. The following description is made according to the accompanying drawings.

### BRIEF DESCRIPTION OF THE DRAWINGS

FIG. 1 shows the block diagram of the apparatus for decoding a packetized transport stream containing the service to obtain and store the service map information according to the embodiment.

FIG. 2 shows a flowchart of the method for decoding the packetized transport stream to obtain and store the service map information according to the embodiment.

FIG. 3A shows an example of a content table of a program map information in a service map information for a service of a DVB standard.

FIG. 3B shows an example of a content table of an application information in a service map information for a service of a DVB standard.

FIG. 4 shows a block diagram of the apparatus for decoding the packetized transport stream to perform the application according to the embodiment.

### DETAILED DESCRIPTION OF THE INVENTION

In the embodiment of the invention, a service map information corresponding to a particular service is obtained and stored when the particular service, containing a program and an application, is performed. The service map information is then referred when the service is chosen in the next time to quickly perform the service again.

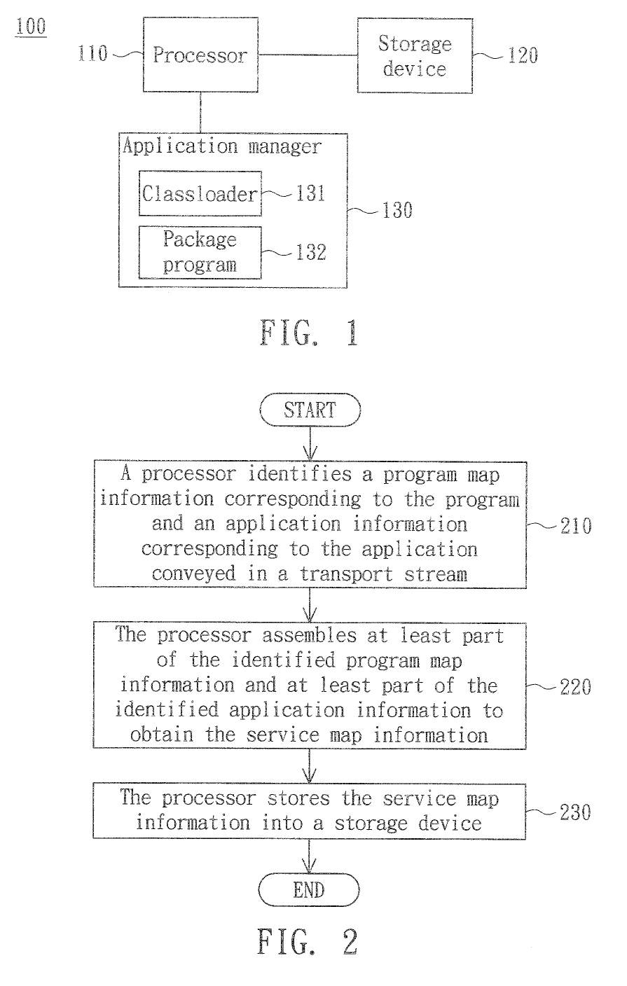

FIG. 1 shows the block diagram of the apparatus for decoding a packetized transport stream containing the service to obtain and store the service map information according to the embodiment. Referring to FIG. 1, the apparatus 100 includes a processor 110, a storage device 120, and an application manager 130.

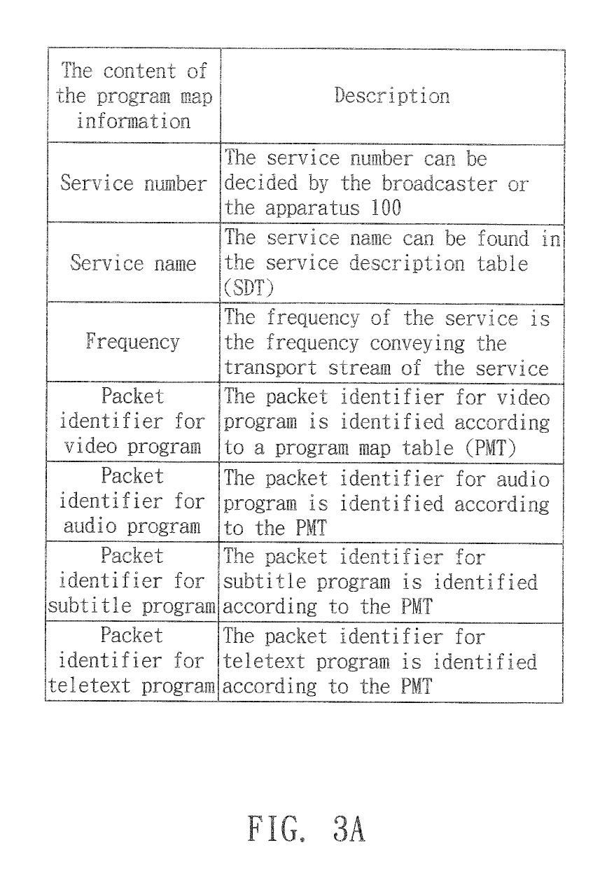

FIG. 2 shows a flowchart of the method for decoding the packetized transport stream to obtain and store the service map information according to the embodiment. Firstly, in step 210, the processor 110 identifies a program map information corresponding to the program and an application information corresponding to the application conveyed in the transport stream.

Then, in step 220, the processor 110 assembles at least part of the identified program map information and at least part of the identified application information to obtain the service map information. The service map information associates the program with packet identifiers used to identify individual packets of the transport stream that constitute the program, and associates the application with packet identifiers used to identify individual packets of the transport stream for performing the application.

Next, in step 230, the processor 110 stores the service map information into the storage device 120. The service map information can be used to identify the individual packets of the transport stream of the service when the service is chosen again.

The method in FIG. 2 can be applied in the service of the standard, which is based on the global executable MHP (GEM). In the standard, the application is implemented by a java program, and the individual packets for performing the application are transmitted through a DSMCC (Digital Storage Media Command and Control) object carousel. Thus, the method in FIG. 2 can be applied in the service of, for example, the advanced television systems committee (ATSC) standard, the OpenCable standard and the digital video broadcast (DVB) standard.

In the embodiment, the service of the DVB standard is taken as an example, to explain the operation of the apparatus 100 and the method more detailed as follows according to the embodiment. In this example, the service contains an application and a number of programs, which includes a video program, an audio program, a subtitle program, and a teletext program.

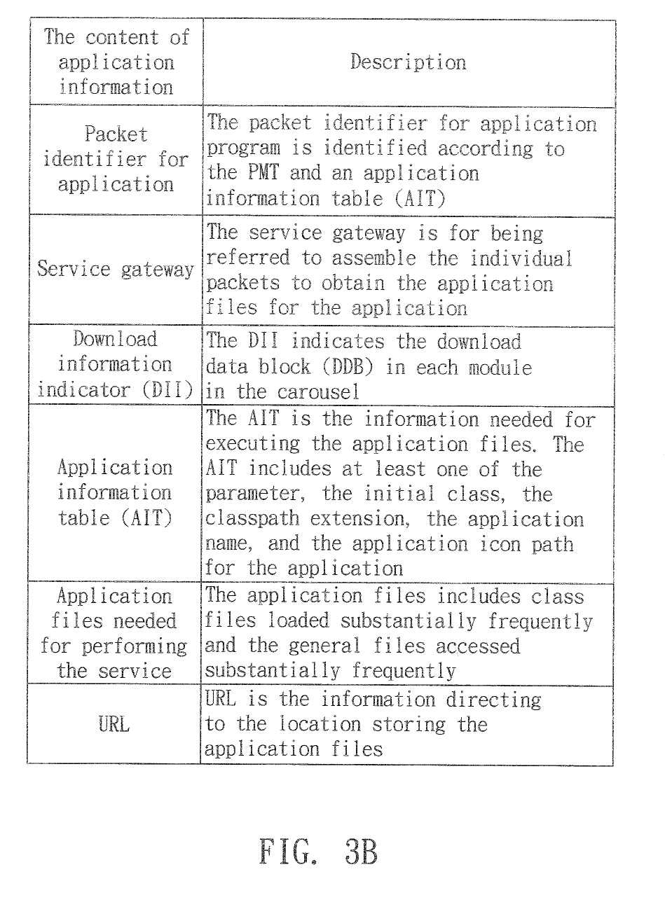

FIG. 3A shows an example of a content table of the program map information in the service map information, which is obtained by applying the method according to the embodiment, for the service of the DVB standard. In this example, the program map information in the service map information includes service number, service name, frequency of the service, packet identifier for the video program, packet identifier for the audio program, packet identifier for the subtitle program, and packet identifier for the teletext program.

FIG. 3B shows an example of a content table of the application information in the service map information. The application information in the service map information includes the packet identifier for the application, the service gateway, the download information indicator (DII), the application information table (AIT), the application files needed for performing the application, and an uniform resource locator (URL) for the application.

In step 210, the program map information, including the service number, the service name, and the frequency of the service, packet identifiers for the programs, is identified. The service number can be provided by the broadcaster or the apparatus 100. The service name can be found in the service description table (SDT). The frequency of the service is the frequency conveying the transport stream of the service.

In step 210, according to a program map table (PMT) of the service, the packet identifier for each of the programs is identified. In the DVB standard, each individual packet has its own packet identifier, and the PMT associates each of the programs with a packet identifier. The transport stream has a number of elementary streams. These elementary streams includes audio stream, video stream, and so on. Each elementary stream has a number of packets with the same packet identifier (PID). For example, the packet identifier Pid1 is identified as the PID of video stream for the video program according to the PMT, and the packet identifiers Pid2, Pid3, and Pid4 are identified as the PIDs for elementary streams of the audio program, the subtitle program, and the teletext program, respectively.

Besides, in the step 210, the application information, including the packet identifier for the application, the service gateway, the DII, the AIT, the application files needed for performing the application, and the URL contained in the application information, is also identified.

In the example, the individual packets for performing the application are transmitted through a DSMCC (Digital Storage Media Command and Control) object carousel carried by a particular elementary stream. The carousel carries a number of modules, each of which is composed of a number of packages. Packages of different modules are sent in turn. The individual packets for performing the application have also their own packet identifier. The packet identifier for the application in FIG. 3B can be obtained according to the PMT and a component tag in a transport protocol descriptor of an application information table (AIT) for the application. From PMT, the elementary stream of the carousel is obtained, and then the PID for the application is obtained by further referring to AIT. For example, the packet identifier Pid5 is identified as the packet identifier for the application according to the component tag and the PMT.

The service gateway in the DSMCC standard in the application information in FIG. 3B records the information describing data structure of the carousel for the application files corresponding to the application. The DII, which is pointed by the service gateway, describes the modules in the carousel. The download data block (DDB) for storing the body of the files of the application can be found according to the DII. After the DDB is found according to the DII and the service gateway, the individual packets for performing the application are assembled to get the application files.

The AIT in the application information in FIG. 3B is the information needed for executing the application files when the service is to be performed. The AIT includes at least one of the parameter: the initial class, the classpath extension, the application name, and the application icon path for the application.

The application files in the application information in FIG. 3B are the application files needed for performing the application. Among all of the application files corresponding to the application, some application files are needed when the service is performed. The application files needed for performing the service are the files which are executed frequently when the service is performed. To save the space of the storage device 120, preferably, only the application files needed for performing the service are to be stored as part of the application information.

How to determine whether the application file is needed for performing the application is described as follows. In this embodiment, the application manager 130 of the apparatus 100 executes some of all application files when the service is performed and whether or not the executed application file is needed for performing the application is determined by the application manager 130.

The application manager 130 includes a classloader 131 and a package program 132. There are two categories of the application files, one is the class file, and the other is the general file. The class files are executable, while the general files are data files, for example, picture files, audio/video files, image files, etc. In the DVB standard, the application is implemented by a java program, which is constituted by a number of class files. The general files, such like an icon file or a background sound file, are used by the application when the class files are executed.

The class files are loaded by the classloader 131 in the application manager 130. The classloader 131 records the number of times that each class file is loaded. By referring to the number of times, it is decided which class files are loaded frequently. When the number of times of some class file loaded by the classloader 131 in a particular period is over a first threshold, then the class file is determined to be the class file which is loaded frequently, and to be needed for performing the service. Then the class file is stored as part of the application information.

For example, the particular period is 48 hours and the first threshold is 10. Thus, if a class file has been loaded more than 10 times during 48 hours, then the class file is taken as part of the application information.

The general files are accessed by the package program 132. Preferably, the package program 132 is DSMCC package (org.dvb.dsmcc) or standard java io package (java.io), which are provided by a middleware. Generally, the application access the general files through the package program 132. Before the package program 132 opens the general file, the package program 132 will firstly determine the application which generates the request to access the general file. The package program 132 records the number of times that each general file is accessed by the application, so as to decide which general files are accessed frequently. When the number of times that a general file is accessed by the package program 132 in a particular period is over a second threshold, then the general file is determined to be needed for performing the service. Then the general file is taken as part of the application information.

In the embodiment, the particular period, the first and the second thresholds can be set according to the memory size of the storage device 120, the number of stored class files and general files in the storage device 120 are decided accordingly. If the memory size of the storage device 120 is small, the first and the second threshold are set higher, therefore only the most needed class files and general files are taken as part of the application information.

In the DVB standard, some application files may be stored in a location in a network, and needs to be downloaded via a return channel, which is used to communicate with the broadcaster, when the service is to be performed. In FIG. 3B, the uniform resource locator (URL) is the information directing to the location storing the application files. The URL can be found in the transport protocol descriptor in the AIT.

After step 210, in which the program map information in FIG. 3A and the application information in FIG. 3B are identified, the identified application information and the program map information are assembled to obtain the service map information in step 220. The service map information is then stored into the storage device 120 in step 230.

In this example, the program map information and the application information in the service map information is exemplified by FIGS. 3A and 3B. However, in practice, the content of the service map information can contain only part of the tables in FIGS. 3A and 3B. For example, the processor 110 determines how much content in FIGS. 3A and 3B are to be stored according to the efficiency of the processor 110 and the memory size of the storage device 120.

The apparatus 100 according to the embodiment obtains and stores the service map information, which can be referred to quickly perform the service when the service is chosen again. The apparatus for decoding the packetized transport stream to quickly perform the application according to the stored service map information is described in detail as follows.

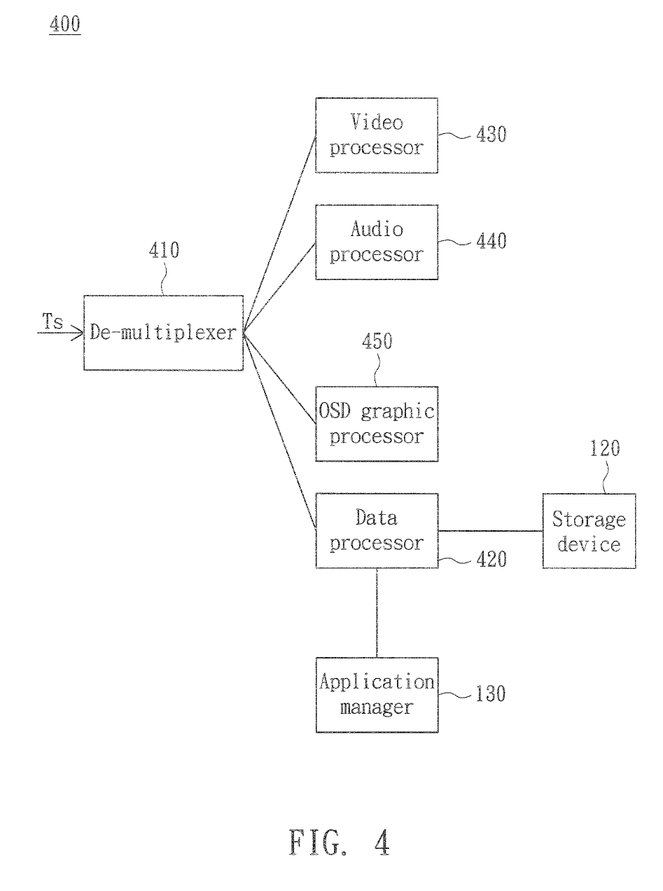

FIG. 4 shows a block diagram of the apparatus for decoding the packetized transport stream Ts to perform the application according to the embodiment. In this embodiment, the apparatus 400 is exemplified to perform the service of the DVB standard according to the service map information in FIGS. 3A and 3B.

Referring to FIG. 4, the apparatus 400 includes a de-multiplexer 410, a data processor 420, a video processor 430, an audio processor 440, an on-screen-display (OSD) graphic processor 450, the storage device 120, and the application manager 130.

When receiving the transport stream Ts, the de-multiplexer 420 de-multiplexes the transport stream Ts to separate the individual packets constituting the video program, the packets constituting the audio program, the packets constituting the OSD program, the packets for performing the application according to the service map information in the storage device 120. The OSD program in the embodiment is the teletext program or the subtitle program.

For example, it is assumed that the service map information associates a video program, an audio program, an OSD program, and an application with packet identifiers Pid1 to Pid4, respectively. According to the service map information, the de-multiplexer 410 identifies the individual packets corresponding to the packet identifier Pid1 in the transport stream Ts as the individual packets constituting the video program, and transmits them to the video processor 430.

Similarly, the de-multiplexer 410 identifies the individual packets constituting the audio program, the individual packets constituting the OSD program, the individual packets for performing the application program according to the service map information in the storage device 120, and transmits them to the audio processor 440, the OSD graphic processor 450, and the data processor 410, respectively.

The video processor 430, the audio processor 440, and the OSD graphic processor 450 then, respectively, process the received identified individual packets to provide the video program, the audio program, and the OSD graphic program.

The data processor 410 reads the service map information from the storage device 120. When receiving the individual packets for performing the application, the data processor 410 assembles the application files constituted by the individual packets for performing the application according to the service gateway and the DII in the service map information.

For some application files stored in some locations in network, the data processor 420 downloads the application files according to the URL in the service map information.

Moreover, the application files needed for performing the service have been stored as part of the service map information. Therefore, the application manager 130 can execute the application files needed for performing the service directly.

After the application files are obtained, the application manager 130 executes the application file according to the AIT in the service map information, so as to perform the application.

The advantages of using the service map information stored in the storage device are described as follows. In the conventional method for performing the service, each time when the service is to be performed, it is necessary to wait for the PMT and the AIT first, which associates the programs and the application with the packet identifiers. Then the transport stream is de-multiplexed. However, by storing the service map information, the apparatus 400 according to the embodiment can de-multiplex the transport stream quickly with no need to wait the PMT and the AIT of the service.

In conventional method for performing the service, each time when the service is to be performed, it is necessary to wait for the service gateway and the DII first. Then the individual packets for performing the application can be assembled into application file. However, with the service gateway and the DII stored as part of the service map information, the apparatus 400 according to the embodiment can obtain the application files quickly without needing to wait the service gateway and the DII.

In conventional method for performing the service, for the application files stored in some locations in network, it is necessary to wait for the URL first. Then the data processor 420 can download the application files via the URL. However, with the URL stored as part of the service map information, the apparatus 400 can quickly download the application files from the network.

In the conventional method for performing the application, every time when the service is to be performed, it is necessary to receive the individual packets constituting the application files needed for performing the application and assemble the individual packets to obtain the application files first. Then the application file can be executed to perform the service. However, with the service map information containing the application files needed for the application, the apparatus 400 according to the embodiment can directly execute the application files.

In the conventional method for performing the application, every time when the service is to be performed, it is necessary to wait the AIT first, which is the information needed for executing the application files. However, with the AIT as part of the service map information, the apparatus 400 can execute the application files without waiting the AIT.

Therefore, it is not necessary for the apparatus 400 to wait to get the information from the transport stream to perform the service. With the service map information, the service can be performed quickly when the service is chosen again.

In the embodiment, the apparatus 100 in FIG. 1 decodes the transport stream to obtain and store the service map information, while the apparatus 400 in FIG. 4 decodes the transport stream to perform the service according to the service map information. In practice, the apparatuses 100 and 400 can be implemented into one apparatus, for example, a set-top box. In this way, the processor 110 can also perform the functions of the de-multiplexer 410, the data processor 420, the video processor 430, the audio processor 440, and the OSD processor 450. The application manager 130 can be part of a middleware, for example, a media home platform (MHP).

In the embodiment, the service is exemplified as the service of the DVB standard as an example. However, in practice, the service is not limited to be of the DVB standard. The apparatus for decoding the transport stream to obtain and store the service map information and the apparatus for decoding the transport stream to perform the service can be applied to the service of other GEM-based standard, in which the application is by a java program, and the individual packets for performing the application are transmitted through the DSMCC object carousel. For example, the service can also be of the ATSC standard or the OpenCable standard. For the service of the ATSC standard, the middleware is Advanced Common Application Platform (ACAP). For the service of the OpenCable standard, the middleware is OpenCable Application Platform (OCAP).

In the embodiment, the stored service map information includes the information for identifying the individual packets, the information described the data structure for assembling the application files, the information for executing the application files, and even the application file needed for performing the service. With the stored service map information, when the service is chosen again, the service can be performed very quickly according to the stored service map information, without waiting the necessary information for the service.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for decoding a packetized transport stream containing a service comprising a program and an application, the method comprising:
identifying a program map information corresponding to the program and an application information corresponding to the application conveyed in the transport stream;
assembling at least part of the identified program map information and at least part of the identified application information to obtain a service map information, the service map information associating the program with packet identifiers used to identify individual packets of the transport stream that constitute the program, and associating the application with packet identifiers used to identify individual packets of the transport stream for performing the application; and
storing the service map information;
wherein the service map information can be used to identify the individual packets of the transport stream of the service when the service is chosen again.

2. The method according to claim 1, wherein the application information further comprises at least one application file needed for performing the application.

3. The method according to claim 2, wherein the at least one application file comprises at least one class file, the number of times that the at least one class file is loaded by a classloader in a first particular period is over a first threshold.

4. The method according to claim 2, wherein the at least one application file comprises at least one general file, the number of times that the at least one general file is accessed by a package program in a second particular period is over a second threshold.

5. The method according to claim 2, wherein the application information is further for being referred to assemble the individual packets corresponding to the application to obtain the at least one application file.

6. The method according to claim 5, wherein the application information further comprises the information describing the data structure for the at least one application file for assembling the individual packets for performing the application to obtain the at least one application file.

7. The method according to claim 6, wherein the service is of the digital video broadcast (DVB) standard, the application information comprises at least one of the service gateway and the download information indication for the application for assembling the individual packets corresponding to the application to obtain the at least one application file.

8. The method according to claim 1, wherein the service is of the DVB standard, the service map information associates the program with packet identifiers used to identify individual packets of the transport stream that constitute the program according to a program map table, and associates the application with packet identifiers used to identify individual packets of the transport stream for performing the application according to the program map table and an application information table for the application.

9. The method according to claim 8, wherein the application information table comprises at least one of the parameter, the initial class, the classpath extension, the application name, and the application icon path for the application.

10. The method according to claim 1, wherein the application information further comprises the information directing to the location storing the at least one application file corresponding to the application.

11. An apparatus for decoding a packetized transport stream to perform an application, the apparatus comprising:
a storage device for storing a service map information associating the application with packet identifiers used to identify individual packets of the transport stream;
a data processor for reading the service map information from the storage device and generating at least one application file constituted by individual packets of the transport stream for performing the application according to the service map information; and
an application manager for executing the at least one application file according to the service map information, so as to perform the application.

12. The apparatus according to claim 11, wherein the apparatus is further for performing a video program, the service map information further associates the video program with the individual packets constituting the video program, the apparatus further comprises:
a de-multiplexer for de-multiplexing the transport stream to separate the individual packets of the transport stream constituting the video program and the individual packets of the transport stream for performing the application according to the service map information; and
a video processor for processing the identified individual packets of the transport stream to provide the video program.

13. The apparatus according to claim 11, wherein the apparatus is further for performing an audio program, the service map information further associates the audio program with the individual packets constituting the audio program, the apparatus further comprises:
a de-multiplexer for de-multiplexing the transport stream to separate the individual packets of the transport stream constituting the audio program and the individual packets of the transport stream for performing the application according to the service map information;
an audio processor for processing the identified individual packets of the transport stream to provide the audio program.

14. The apparatus according to claim 11, wherein the apparatus is further for performing an on-screen display (OSD) program, the service map information further associates the OSD program with the individual packets constituting the OSD program, the apparatus further comprises:
a de-multiplexer for de-multiplexing the transport stream to identify the individual packets of the transport stream constituting the OSD program and the individual packets of the transport stream for performing the application according to the service map information;
an OSD graphic processor for processing the identified individual packets of the transport stream to provide the OSD program.

15. The apparatus according to claim 11, wherein the service map information further comprises the at least one application file needed for performing the application, the application manager is for reading the at least one application file and executing the at least one application file.

16. The apparatus according to claim 11, wherein the service map information further comprises the information directing to the location storing the application file corresponding to the application.

17. An apparatus for decoding a packetized transport stream containing a service comprising a program and an application, the apparatus comprising:
a storage device; and
a processor for identifying a program map information corresponding to the program and an application information corresponding to the application conveyed in the transport stream, assembling at least part of the identified program map information and at least part of the identified application information to obtain a service map information, and storing the service map information into the storage device;
wherein the service map information associates the program with packet identifiers used to identify individual packets of the transport stream that constitute the program, and associates the application with packet identifiers used to identify individual packets of the transport stream for performing the application;
wherein the service map information can be used to identify the individual packets of the transport stream of the service when the service is chosen again.

18. The apparatus according to claim 17, wherein the apparatus further comprises:
an application manager for storing at least one application file needed for performing the application as part of the application information of the service map information into the storage device

19. The apparatus according to claim 18, wherein the at least one application file comprises at least one class file, the application manager comprises a classloader for loading the at least one class file, the number of times that the at least one class file is loaded by the classloader in a second particular period is over a first threshold.

20. The apparatus according to claim 18, wherein the at least one application file comprises at least one general file, the application manager comprises a package program for accessing the at least one general file, the number of times that the at least one general file is accessed by the package program in a second particular period is over a second threshold.

21. The apparatus according to claim 18, the processor is further for assembling the individual packets corresponding to the application according to the service map information to obtain the at least one application file.

22. The apparatus according to claim 21, wherein the service map information further comprises the information describing the data structure of the at least one application file for assembling the individual packets for performing the application to obtain the at least one application file.

23. The apparatus according to claim 22, wherein the service is of the DVB standard, the service map information comprises at least one of the service gateway and the download information indication for the application for assembling the individual packets corresponding to the application to obtain the at least one application file.

24. The apparatus according to claim 17, wherein the service is of the DVB standard, the service map information associates the program with packet identifiers used to identify individual packets of the transport stream that constitute the program according to a program map table, and associates the application with packet identifiers used to identify individual packets of the transport stream for performing the application according to the program map table and an application information table for the application.

25. The apparatus according to claim 24, wherein the application information table comprises at least one of the parameter, the initial class, the classpath extension, the application name, and the application icon path for the application and the combination thereof.

26. The apparatus according to claim 17, wherein the service map information further comprises the information directing to the location storing the at least one application file corresponding to the application.
